(19) United States
(12) Patent Application Publication
(10) Pub. No.: US 2024/0289825 A1
(43) Pub. Date: Aug. 29, 2024

(54) Methods And Systems For Use In Defining Advancement Of Seed Products In Breeding

(71) Applicant: Monsanto Technology LLC, Saint Louis, MO (US)

(72) Inventors: Ankit SANGWAN, Bangalore (IN); Qunyuan ZHANG, Ballwin, MO (US)

(21) Appl. No.: 18/587,219

(22) Filed: Feb. 26, 2024

(30) Foreign Application Priority Data
Feb. 27, 2023 (IN) 202311013170

(51) Int. Cl. G06Q 30/0204; G06Q 50/02

(52) U.S. Cl. CPC G06Q 30/0205; G06Q 50/02

(57) ABSTRACT

Systems and methods for defining advancement of products in breeding are provided. One example computer-implemented method includes accessing, by a computing device, a trained model specific to a segment, where the segment is defined by a relative maturity (RM) and/or a region and accessing data specific to multiple inbred lines, where the data includes best linear unbiased predictions (BLUPs) for one or more traits of the multiple inbred lines. The computer-implemented method also includes identifying pairs of the multiple inbred lines as combinations for potential hybrids, calculating, with the trained model, a probability of advancement for individual ones of the potential hybrids in a breeding pipeline, and advancing one or more of the ones of the potential hybrids into the breeding pipeline, based on the calculated probability of advancement for the individual ones of the potential hybrids.

### CROSS-REFERENCE TO RELATED APPLICATION

This application claims the benefit of, and priority to, Indian patent application Ser. No. 20/231,1013170, filed Feb. 27, 2023. The entire disclosure of the above application is incorporated herein by reference.

### FIELD

The present disclosure generally relates to methods and systems for use in defining advancement of products (e.g., seed products, etc.) in breeding, and in particular, to methods and systems for use in selecting products (e.g., seed products, etc.) for advancement in breeding pipelines, for specific segments, based on historical data and predictive modeling.

### BACKGROUND

This section provides background information related to the present disclosure which is not necessarily prior art.

Development and/or breeding of plants is often performed in the context of a breeding pipeline, especially for large commercial implementations. In connection with moving (or advancing) plants through the breeding pipeline, breeders rely on characteristics of the plants (and lines of the plants) and plants produced from the plants/lines of plants in making decisions to move or advance the plants (and/or seeds from the plants). The characteristics are generally collected through testing and trials related to the plants and/or lines of the plants. For example, plants resulting from breeding may be tested for phenotypic traits, such as height, stalk strength, and yield, etc., and also, for genotypic traits. Decisions are then made with regard to plant development and/or breeding, and also to movement of plants through the breeding pipeline, based on the characteristics and considerations related thereto.

### SUMMARY

This section provides a general summary of the disclosure and is not a comprehensive disclosure of its full scope or all of its features.

Example embodiments of the present disclosure generally relate to methods for defining advancement of products in breeding programs. In one example embodiment, such a method generally includes: accessing, by a computing device, a trained model specific to a segment, the segment defined by a relative maturity (RM) and/or a region; accessing, by the computing device, data specific to multiple inbred lines, the data including best linear unbiased predictions (BLUPs) for one or more traits of the multiple inbred lines; identifying pairs of the multiple inbred lines as combinations for potential hybrids; calculating, by the computing device, with the trained model, a probability of advancement for individual ones of the potential hybrids in a breeding pipeline; and advancing (e.g., directing, assigning, etc.) one or more of the ones of the potential hybrids into the breeding pipeline, based on the calculated probability of advancement for the individual ones of the potential hybrids.

Example embodiments of the present disclosure also generally relate to non-transitory computer-readable storage media including executable instructions for defining advancement of products in breeding programs, which when executed by at least one processor, cause the at least one processor to perform one or more of the operations included in the above method.

Example embodiments of the present disclosure also generally relate to systems for defining advancement of products in breeding programs. In one example embodiment, such a system generally includes at least one computing device configured to: access a trained model specific to a segment, the segment defined by a relative maturity (RM) and/or a region; access data specific to multiple inbred lines, the data including best linear unbiased predictions (BLUPs) for one or more traits of the multiple inbred lines; identify pairs of the multiple inbred lines as combinations for potential hybrids; calculate, with the trained model, a probability of advancement for individual ones of the potential hybrids in a breeding pipeline; and advance (e.g., direct, assign, etc.) one or more of the ones of the potential hybrids into the breeding pipeline, based on the calculated probability of advancement for the individual ones of the potential hybrids.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 illustrates an example system of the present disclosure configured for defining products to be advanced (e.g., directed, etc.) into a breeding pipeline;

FIG. 2 is a block diagram of an example computing device that may be used in the system of FIG. 1;

FIG. 3 illustrates a flow diagram of an example method, which may be used in (or implemented in) the system of FIG. 1, for use in defining products to be advanced in a breeding pipeline; and

FIG. 4 illustrates an example segment of training data that may be used to train and/or validate a model in the system of FIG. 1 and/or the method of FIG. 3.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Breeders often rely on test data for lines of plants in order to make decisions, on a per product basis, to advance or not advance plants in a breeding pipeline (or breeding environment or breeding program). The decisions may be problematic when hundreds or more of lines of plants are available, whereby human breeders are unable to account for all, or even a substantial portion, of the data known about the lines, individually and relatively. When additional factors, such as, for example, diversity, etc., are considered, the decisions are beyond human capabilities. As such, in instances involving large amounts of data for large numbers of lines of plants, the decisions to advance or not advance the plants may be arbitrary, non-uniform and inefficient, considering the available data.

Uniquely, the systems and methods herein provide for making decisions to advance or not advance plants in a manner different than by individual human breeders, etc., for example, to account for the different data associated with the lines, as well as the volume of data known about the lines, without the data itself and/or volume of such data (e.g., based on sample size, etc.) limiting and/or impacting the decision. In particular, for example, the systems and methos herein provide for defining one or more potential hybrids, which are predicted to be advanced in one or more breeding pipelines, based on a trained model and best linear unbiased prediction (BLUP) data associated therewith. For instance, in one example, a mixed model may utilize field trial data as input and generate a BLUP as output, and then a machine learning model may utilize the BLUP as input and generate one or more predicted scores for candidate products as output. The candidate products may then be ranked, and one or more of the candidate products may be selected based on the corresponding predicted scores.

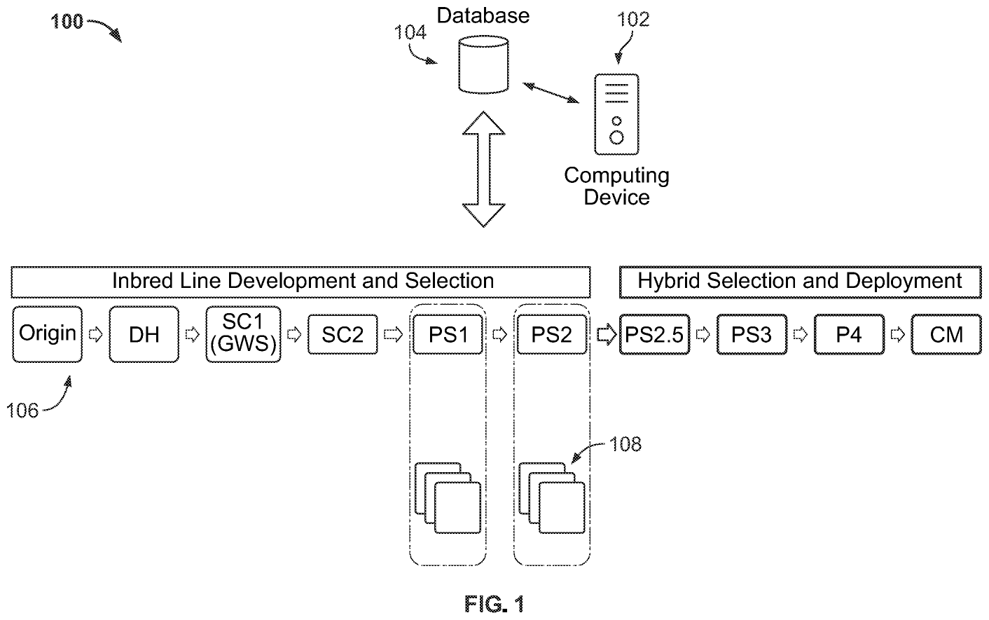

FIG. 1 illustrates an example system 100 in which one or more aspects of the present disclosure may be implemented. Although the system 100 is presented in one arrangement, other embodiments may include the parts of the system 100 (or additional parts) arranged otherwise depending on, for example, types of seeds and/or plants included in the system 100, sources of data for the seeds and/or plants, types of data (e.g., phenotypic data, geolocation data, etc.), etc.

In the example embodiment of FIG. 1, the system 100 generally includes a computing device 102 and a database 104. The database 104 is coupled to (and/or otherwise in communication with) the computing device 102, as indicated by the arrowed line. The computing device 102 is illustrated as separate from the database 104 in FIG. 1, but it should be appreciated that the database 104 may be included, in whole or in part, in the computing device 102 in other system embodiments.

As shown in FIG. 1, the system 100 includes a breeding pipeline 106 (broadly, a breeding environment or breeding program), which includes various different stages for testing and advancing seeds. The stages may include any different variety of stages, based on, for example, the particular type of plants being bred (and/or seed being grown) in the pipeline 102. In this example embodiment, the plants includes maize or corn, whereby the plants, which are a hybrid, are a combination (or cross) of a female line and a male line (for example, denoted F+M). Further, in some instances, breeders (or growers) may use two very close females, Fa and Fb, to create a new female, for example, F=Fa+Fb, where F+M=(Fa+Fb)+M=MSC+M. In such instances, the MSC (modified single cross) is a female line produced by the cross of the two closely related female lines Fa and Fb (e.g., MSC=Fa+Fb, etc.). That said, the plants herein may be products of hybrids from two or three or more lines. Further, it should be appreciated that the present disclosure is applicable to plants other than corn, such as, for example, soybeans, rice, potato, tomato, other hybrid plants, etc.

In the illustrated embodiment, the breeding pipeline 106 includes multiple stages, including: origin, double haploid (DH), multiple screening stages (SC1, SC2) (e.g., for testing, evaluating, etc. the seeds/plants; etc.), multiple product stages (PS1, PS2, PS2.5, PS3, PS4) (e.g., for growing, etc. the seeds/plants; etc.), and a commercial testing stage (CM). The origin stage generally includes origin population development and selection, for example, where inbred lines are developed from origin populations. The DH stage generally includes double haploid development and selection, where a double haploid is a breeding line with homozygous alleles at all genetic loci. The SC1 stage includes a first stage of line screening, and the SC2 stage includes a second stage of line screening. The different product stages include different testing of hybrids (broadly, products) for selection and advancement to a subsequent product stage. And, the CM stage includes a stage at which commercial products are tested and compared (e.g., for commercial use, sale, etc.). Other stages or other combinations of stages may be included in other breeding pipelines, for example, depending on the particular type of plant, etc.

The breeding pipeline 106 may be specific to a region, or may be located in a particular region (i.e., a target region of the products from the pipeline), whereby the testing, screening, analysis, selections, etc. included in the breeding pipeline is specific to the region for which products of the pipeline are destined. The breeding pipeline 106 may be otherwise specific to a target product in whole or in part, such as, for example, by product type or trait (e.g., relative maturity, etc.), market, sub-market, etc.

As shown in FIG. 1, each of the stages of the pipeline 106 include and/or are associated with one or more fields 108 (e.g., in which the seeds may be planted and the plants may be grown, etc.). The fields 108 are shown as included in stages PS1 and PS2 for purposes of illustration, but it should be appreciated that each of the stages may be associated with one or more same or different fields. In this way, the breeding pipeline 106 may include dozens, hundreds, or thousands, or more or less fields 108, which are owned, operated and/or controlled, at least in part, by a breeder (or multiple breeders) (not shown) associated with the breeding pipeline 106. The fields 108 may include any different type of growing space (e.g., plots of land, greenhouses, growing pots or beds, etc.), of various sizes/acreages, in one or more regions, states, territories, counties, countries, etc.

In connection with one or more breeding operations for one or more types of plants, the fields 108 are planted year over year (or season over season), with the same or different plants, and then harvested consistent with seasons of the plants included therein. The seeds planted in the fields 108, in this example embodiment, include multiple different types or varieties of seeds/plants. Each of the seeds, in turn, may include an inbred line or a hybrid (i.e., a combination of lines), depending on the particular stage of the breeding pipeline 106, including multiple different varieties and/or types of seeds at multiple different stages thereof. Across the multiple fields of one or more stages, and over multiple years, the system 100 may involve hundreds, thousands, tens of thousands, hundreds of thousands or more (or less) inbred lines and/or hybrids. The inbred lines in turn may provide hundreds or thousands or more distinct hybrids, i.e., one female inbred line and one male inbred line. In this example, the seeds are corn or maize, but may be otherwise in other embodiments. Again, as noted above, the present disclosure is applicable to plants such as, for example, corn, soybeans, rice, potato, tomato, other hybrid plants, etc.

As part of the operations of the breeding pipeline 106 (and the different stages included therein), then, substantial data related to the lines, hybrids, phenotypic performance, fields, etc., is collected, organized and stored in the database 104.

In particular, for example, the data may include various different types of data, which may represent, without limitation, characteristics/traits of the plants (or seeds) prior to planting, at planting, during growing, and/or during/after harvest (or therebetween); characteristics of the fields, conditions of the fields and/or characteristics/conditions associated therewith before, during and/or after planting of the fields; and/or timing associated with the planting and/or harvesting of the plants; etc.

Further, the data may be indicative of each specific crop/seed, by identifier (e.g., unique number, etc.) planted in the fields 108, a type of the plant (e.g., corn, etc.), a genomic description of the plant (e.g., trait stack, etc.), an identification of the parent lines (e.g., for hybrids, etc.), relative maturity (RM), etc. The data also includes a planting date of the crop in the given field 108, any treatments (e.g., fertilizer, herbicide, insecticide, etc.) applied to the field 108, soil conditions, precipitation, solar radiation, moisture, etc. The data may also include, without limitation, performance data related to the line, such as, for example, yield, height, lodging, resistance, strength, etc.

The data may also include data indicative of phenotypic traits, etc., of the lines or hybrids, which may be expressed, summarized, processed, or aggregated in one or more different manners. For example, the data indicative of phenotypic traits may be compiled into one or more best linear unbiased predictions (BLUPs) for the specific traits. For example, yield of a line may be expressed as a BLUP, which is a linear regression or adjusted mean of the yield data based on the historical data for the inbred line (e.g., over one year, two years, or three years, etc.). It should be appreciated that the data in the database 104 may include BLUPs for one or various traits of each of the inbred lines included in the database 104 for one or more of the same or different intervals. For example, the database 104 may include individual BLUPs, per line (for one or more intervals (e.g., year, multiple years, etc.), etc.), for a three year interval, for the following traits of the lines: ear height (EHT), green snap percentage (GSPP), moisture best estimation (MST_BE), plant height (PHT), root lodging percentage (RTLP), selection index (SLIN), stalk lodging percentage (STLP), total test weight (TWT), and yield best estimation (YLD_BE), etc. It should be appreciated that more or less, or different, traits may be represented by BLUPs or otherwise in other system embodiments.

In this example embodiment, the data may further include, for certain hybrids (produced form the lines), an indication of the lines from which the hybrid was created, the first year in which the plant was tested, and a fate of the hybrid, etc. The fate of the hybrid indicates, for example, an outcome of an advancement decision for the hybrid in the breeding pipeline 106, relative, for example, to a specific threshold. For example, the breeding pipeline 106 may include a number of stages, as illustrated in FIG. 1, for example, and the advancement of the hybrid is a 1 if the hybrid achieves a particular stage in the pipeline 106 and a 0, if not. In this example, the breeding pipeline 106 includes historical data indicative of prior inbred selections and hybrid selections. In this example the hybrid selection stages include PS2.5, PS3, PS4, and CM, as shown in FIG. 1. In connection therewith, the fate of the hybrid including the line may be based on advancing beyond the PS2.5, PS3, etc. stages of the breeding pipeline 106. It should be appreciated that one or more similar or distinct stage thresholds may be relied upon to determine fate in other system embodiments.

The historical data in the database 104 may be organized by year (e.g., Y₁, Y₂, Y₃ . . . . Y_{N}, etc.), or by plant, line, or field, or by location (e.g., region, territory, state, etc.). In each year, for example, the data is then organized further by crop or plant, or by region. In general, the data may be organized by region, or market, or submarket. In doing so, a region may have multiple markets, and a market may have multiple submarkets. A submarket, then, may include a particular type of product, for example, white corn, waxy corn, silage corn, etc. For example, data for the United States may include data for all of the United States together, or data for the Midwest and/or South, etc. may be separate from the data for the rest of the United States. Similarly, data for Europe may be included together or separated by region. And, further, in the above examples, the data may be separated based on the market size associated with the products (e.g., small, medium or large markets, etc.), and further still, sub-markets therein (e.g., specific product types, etc.). It should be appreciated that the historical data may be stored consistent with the different regions, years, markets, etc., or may be merely accessed (or filtered) consistent with a particular market, region, year, etc.

In this example embodiment, the computing device 102 is configured to generate (or develop) and/or train a model, to calculate a probability for a particular hybrid to advance beyond a specific stage of the breeding pipeline 106, based on the historical data in the database 104.

In particular, the computing device 102 is configured to train a model based on, in this example, certain hybrids, which are composed of two lines, for example, a male inbred line and a female inbred line, and data specific to those hybrids. The model, in this example embodiment, includes a random forest model (e.g., with approximately one thousand trees (or more or less), and a minimum node size of about ten (or more or less), etc.). The training data for the model includes the BLUP data of the inbred lines for one or more phenotypic traits (e.g., as listed above, etc.) and fate data for the given hybrid (e.g., whether it was advanced beyond a specific stage in the breeding pipeline 106, etc.). The training data may be specific to a region, market, and/or trait of the plant, etc. (e.g., North America, RM 100, etc.). Moreover, the specific traits may be different for different regions, markets, and/or plants, etc. (e.g., EHT may be used for training a model in North America, but not for India, etc.). In this manner, the model is trained specifically to the target breeding pipeline 106 for predicting advancement of hybrids.

Further, in this example, a segment of the training data, for example, a validation subset, is left out of the training, while a training subset is used to train the model. It should be understood that the training subset and the validation subset may be further separated to train the model in stages, or train the model per interval (e.g., a year, etc.), or in accordance with other criteria by which the data may be separated. After training, the computing device 102 is then configured to validate the trained model based on the validation subset. As such, when validated, the trained model is configured to predict, as a probability, the advancement of hybrids or combinations of lines through the pipeline 106 based on BLUP data for the lines. To this point, when the advancement prediction data is consistent with the observed advancement data, subject to an applicable threshold, the trained model is accurate. A percentage of correct predictions may provide a performance, and when the performance of the trained model is as desired or expected, the trained model is designated, by the computing device 102, for use in providing advancement predictions as described herein. In connection with the above, the data included in the training subset and the data included in the validation subset may be separated randomly and/or based on one or more years left out of schemes, etc.

Next in the system 100, for a request (or in response to such a request) for identifying hybrids to advance in the breeding pipeline 106, for example, the computing device 102 is configured to define potential hybrids including one female line and one male line from the lines represented in the database 104, based on random or non-random permutations thereof (e.g., which are new, unique or not tested prior, etc.). It should be appreciated that the identification of permutations may be limited based on the inbred lines, for example, where the request is specific to a type of plant, a region and/or relative maturity, etc. In one example, the computing device 102 is configured to identify each possible combination of inbred lines (and/or related hybrid), and then to filter out or eliminate ones of the hybrids which have previously been tested, planted or otherwise identified, etc. (as each is already in test or verified), or ones of the hybrids inconsistent with the breeding pipeline 106 and/or request (e.g., different relative maturity, etc.).

Based on the identified potential hybrids (which are not eliminated or filtered out), the computing device 102 is configured to then leverage the trained model to predict the probability of advancement of the combination of inbred lines (or corresponding hybrids). The probabilities may be used directly, or the hybrids may be “binned” or separated into bins based on the probabilities. The computing device 102, for example, may be configured to output the hybrids and/or probabilities in one or more interfaces, directly, or potentially, to separate the hybrids into five, ten, twenty, or more of less bins, and then output the hybrids and/or probabilities (and/or bins) in one or more interfaces for one or more of the bins. The output may include a display of the hybrids and/or probabilities (and/or bins), which may then permit the selection of the potential hybrids to advance to the pipeline 106 (automatically or by a user or breeder, etc.).

The computing device 102 is then configured to advance (or direct) (or cause or instruct the advancement of or direction of) the selected hybrid(s) to (or into) the breeding pipeline 106, into a pool of hybrids (e.g., based on probabilities of the hybrids, or a user selection/input based on the user's review of probabilities, etc.) to be tested, wherein the hybrids are created (from the corresponding inbred lines), planted, grown, harvested, and tested as part of the pipeline 106. For instance, in one example, at least one plant is planted, consistent with the given inbred lines, in one of the fields 108 included in the breeding pipeline 106, whereby the probability associated with the corresponding potential hybrid(s) may be validated. In doing so, the computing device 102 may be configured to transmit the selected hybrid(s) (e.g., via executable instructions generated by the computing device 102 and including or identifying the selected hybrid(s), etc.) to a planter (e.g., to a computing device associated with the planter (e.g., on board the planter, associated with an operator of the planter, etc.). In response, the planter is configured (e.g., by the computing device associated with the planter, etc.) to traverse the field(s) 108 and plant the selected hybrid(s). Then, once the planted hybrid(s) are grown (e.g., following a particular amount of time from planting, following a user input, etc.), the computing device 102 may be configured to direct a harvester to the field(s) to harvest the grown hybrid(s), whereby the harvested hybrid(s) may be validated.

As used herein, the model may refer to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein may have a practical application in a computer in the form of stored executable instructions and data that implement the model using the computer. The model may include a model of past events of the plants and/or the pipeline 106, a model of the current status of the plants and/or the pipeline 106, and/or a model of predicted events of the plants and/or the pipeline 106.

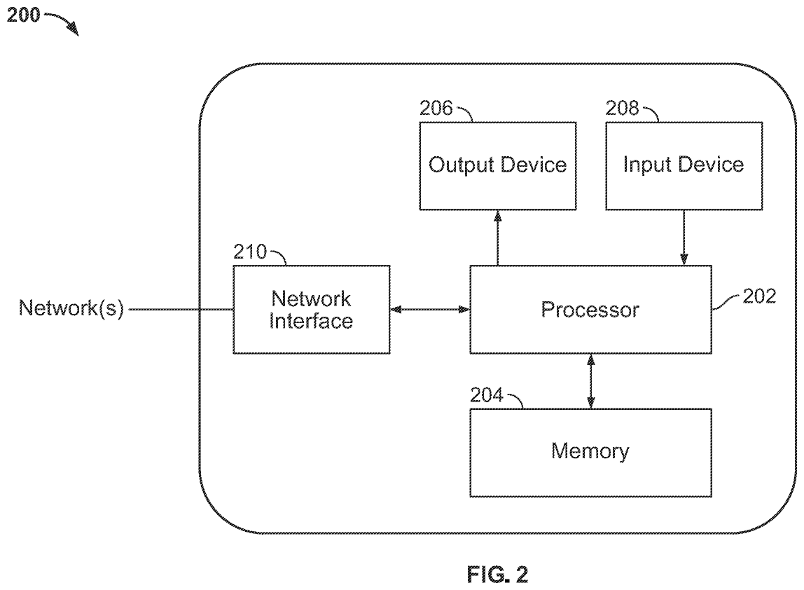

FIG. 2 illustrates an example computing device 200 that may be used in the system 100 of FIG. 1. The computing device 200 may include, for example, one or more servers, workstations, personal computers, laptops, tablets, smartphones, virtual devices/machines, etc. In addition, the computing device 200 may include a single computing device, or it may include multiple computing devices located in close proximity or distributed over a geographic region, so long as the computing devices are specifically configured to operate as described herein. In the example embodiment of FIG. 1, the computing device 102 includes and/or is implemented in one or more computing devices consistent with computing device 200. The database 104 may also be understood to include and/or be implemented in one or more computing devices, at least partially consistent with the computing device 200. However, the system 100 should not be considered to be limited to the computing device 200, as described below, as different computing devices and/or arrangements of computing devices may be used. In addition, different components and/or arrangements of components may be used in other computing devices.

As shown in FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, a graphics processing unit (GPU), an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. In connection therewith, the memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media for storing such data, instructions, etc. In particular herein, the memory 204 is configured to store data including, without limitation, models, phenotypic data (e.g., BLUPs, etc.), fate data for lines, hybrids pools, field data, and/or other types of data (historical or otherwise) (and/or data structures) suitable for use as described herein.

Furthermore, in various embodiments, computer-executable instructions may be stored in the memory 204 for execution by the processor 202 to cause the processor 202 to perform one or more of the operations described herein (e.g., one or more of the operations of method 300, etc.) in connection with the various different parts of the system 100, such that the memory 204 is a physical, tangible, and non-transitory computer readable storage media. Such instructions often improve the efficiencies and/or performance of the processor 202 that is performing one or more of the various operations herein, whereby such performance may transform the computing device 200 into a special-purpose computing device. It should be appreciated that the memory 204 may include a variety of different memories, each implemented in connection with one or more of the functions or processes described herein.

In the example embodiment, the computing device 200 also includes an output device 206 that is coupled to (and is in communication with) the processor 202 (e.g., a presentation unit, etc.). The output device 206 may output information (e.g., probabilities, recommendations, etc.), visually or otherwise, to a user of the computing device 200, such as a researcher, grower, technician, etc. It should be further appreciated that various interfaces (e.g., as defined by network-based applications, websites, etc.) may be displayed or otherwise output at computing device 200, and in particular at output device 206, to display, present, etc. certain information or data (as described herein) to the user. The output device 206 may include, without limitation, a liquid crystal display (LCD), a light-emitting diode (LED) display, an organic LED (OLED) display, an “electronic ink” display, speakers, a printer, etc. In some embodiments, the output device 206 may include multiple devices. Additionally or alternatively, the output device 206 may include printing capability, enabling the computing device 200 to print text, images, and the like on paper and/or other similar media.

In addition, the computing device 200 includes an input device 208 that receives inputs from the user (i.e., user inputs) such as, for example, selections of one or more hybrids to advance in the breeding pipeline 106, etc. The input device 208 may include a single input device or multiple input devices. The input device 208 is coupled to (and is in communication with) the processor 202 and may include, for example, one or more of a keyboard, a pointing device, a touch sensitive panel, or other suitable user input devices. It should be appreciated that in at least one embodiment the input device 208 may be integrated and/or included with the output device 206 (e.g., a touchscreen display, etc.).

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks (e.g., one or more of a local area network (LAN), a wide area network (WAN) (e.g., the Internet, etc.), a mobile network, a virtual network, and/or another suitable public and/or private network, etc.), including suitable networks capable of supporting wired and/or wireless communication between the computing device 200 and other computing devices, including with other computing devices used as described herein (e.g., between the computing device 102, the database 104, etc.).

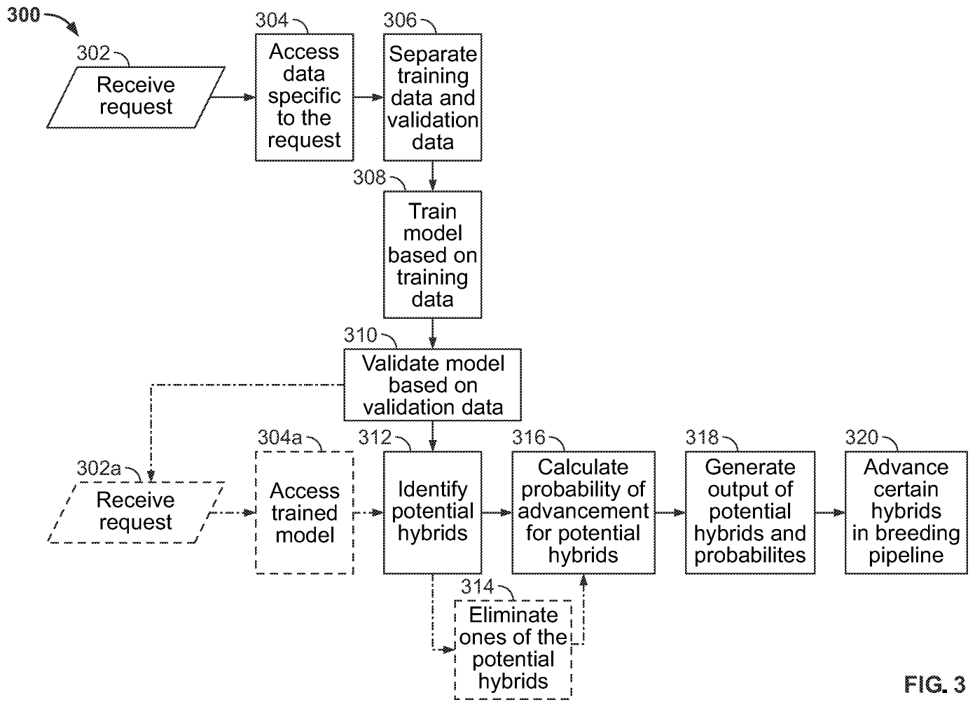

FIG. 3 illustrates an example method 300 for defining products to be advanced in a breeding pipeline. The example method 300 is described herein in connection with the system 100, and may be implemented, in whole or in part, in the computing device 102 of the system 100. Further, for purposes of illustration, the example method 300 is also described with reference to the computing device 200 of FIG. 2. However, it should be appreciated that the method 300, or other methods described herein, are not limited to the system 100 or the computing device 200. And, conversely, the systems, data structures, and the computing devices described herein are not limited to the example method 300.

Initially in the method 300, at 302, the computing device 102 receives a request from a user, such as, for example, a breeder associated with the breeding pipeline 106. The request may include, for example, either a request to train a model for use as described herein, or to define one or more hybrids to be advanced into the breeding pipeline 106. The request, generally, includes an identification of the crop type (e.g., corn, etc.) to be evaluated. The request may also include a geographical region (e.g., North America, India, Europe, United States—Midwest, etc.) (broadly, a market) and one or more traits or characteristics of the plant/seed/crop. The traits or characteristics may include one or more of RM, temperature or temperature ranges, variety designations of the crop type (or submarket) (e.g., white corn versus yellow corn versus waxy corn verses silage corn, etc.), seasonal types (e.g., spring versus summer, etc.), field targets (e.g., wet versus dry, etc.), etc. Other suitable traits or characteristics may be employed, as part of the request, to distinguish the hybrids sought to be advanced into the breeding pipeline 106 as compared to other hybrids.

It should be appreciated that certain traits or characteristics may be assigned by the computing device 102, or as rules associated with the method 300, whereby the limiting traits or characteristics of the hybrids are not included in the request from the user, yet are known to the computing device 102 and imposed as described herein.

In response to the request, the computing device 102 accesses, at 304, data specific to the request. As explained above, the database 104 includes data in various forms, which is representative of various seeds/plants grown in various fields 108, as part of various stages of the breeding pipeline 106, where the data is specific to both inbred lines and also to hybrids. The computing device 102 accesses data for a period of years (e.g., five years, ten years, or more or less, etc.) for which hybrids are associated with fate data, indicating, as explained above, an advancement or not of the hybrids relative to one or more stages of the breeding pipeline 106. Along with the fate data, the accessed data includes various phenotypic traits of the respective inbred lines and hybrids. In this example embodiment, the data is aggregated into BLUPs for the inbred lines contributing to the hybrids, where the BLUPs are each a linear mixed model adjusted mean of the historical data for each inbred line, whereby each phenotypic trait is representative of data over an interval. It should be appreciated that certain phenotypic traits may be represented as BLUPs in the accessed data, while other phenotypic traits may be represented by one or more different aggregates of the data, over time (e.g., mean, average, etc.) in the accessed data.

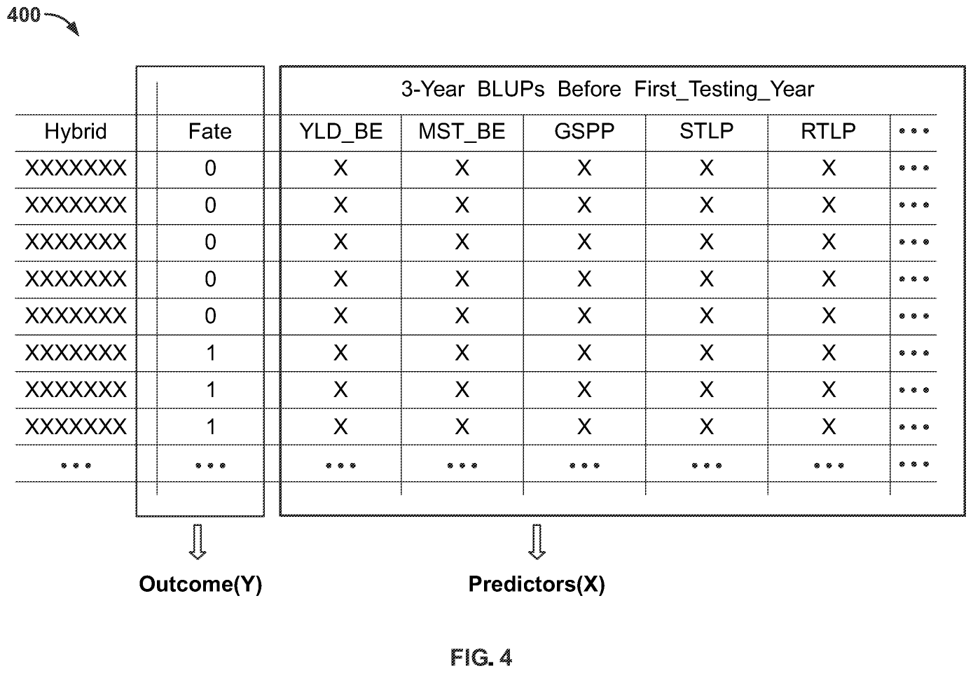

FIG. 4 illustrates an example segment 400 of the accessed data, for example, as maintained in the database 104. As shown, each hybrid is represented in a row of the segment 400. And, the accessed data, or training data, includes fate data (as outcomes) and BLUPs for the inbred lines contributing to the hybrid over three years for each of yield best estimation (YLD_BE), moisture best estimation (MST_BE), green snap percentage (GSPP), stalk lodging percentage (STLP), and root lodging percentage (RTLP) (as predictors). The fate data, in this example, includes an advancement indicator of 0 or 1, where 0 represents no advancement of the hybrid beyond a given stage of the pipeline 106 and 1 represents advancement of the hybrid beyond the given stage. The segment 400 is shown for purposes of illustration only, and therefore, it should be appreciated that other data, in other forms or formats, may be included in the database 104 or other databases (e.g., other predictors, etc.).

In connection with the above, BLUPs may be calculated first for each of male (M) and female (F) inbred lines, and then mid-parent BLUPs may be calculated for each hybrid by taking an average of the BLUPs for the male and female lines. For instance, for a hybrid F+M, the mid-parent BLUP may be calculated as follows: mid-parent BLUP=(BLUP_M+BLUP_F)/2. Further, in some examples, the BLUPs may involve further genomic data. In such examples, the BLUPs may be referred to as gBLUPs (where both the BLUPs and the gBLUPs can be calculated for the same traits).

Referring again to FIG. 3, at 306, the computing device 102 separates the assembled data into training data and validation data. The separation may include dividing the data based on one or more percentages (e.g., 75% training data and 25% validation data, etc.), selected at random or based on one or more patterns. Another manner of separating the training data from the validation data may include one-year-left-out (OYLO), whereby an interval of data is removed as the validation data.

At 308, the computing device 102 trains the model (e.g., a random forest model, etc.), based on the training data. In one example, the computing device 102 trains the model based on a set of training data containing mid-parent BLUPs of multiple traits as predictors (X) and fates (0 and 1) as outcome (Y) (see, e.g., FIG. 4). The training process, then, is to identify a mathematical function (f), which calculates Yp=f(X) as a predicted value. The function is tuned to limit and/or minimize a difference between the predicted value (Yp) and the observed outcome (Y). In some instances, random forest trees may be used to build the function (f), which is a set of decision trees defined by a set of orders and cutoffs of the predictors (X), learned from provided data (predictors (X) and outcomes (Y), for example, as shown in FIG. 4). Then, in applying each tree (e.g., an order and a set of cutoffs of traits, etc.) to the predictors (X) data of a hybrid, the computing device 102 generates f(X)=0 or 1. Additionally, or alternatively, in applying a set of the trees to the predictors (X) and taking the average of the calculated f(X) values, the computing device 102 provides a probability score between 0 and 1, which is the predicted probability of advancement in the pipeline 106 beyond a given stage (e.g., where 0 represents no chance of advancement of the hybrid beyond the given stage and 1 represents definite advancement of the hybrid beyond the given stage, etc.).

The computing device 102 then validates the trained model based on the validation data, at 310. In particular, for each hybrid in the validation data, the computing device 102 provides the predictors (e.g., BLUPs, etc.) from the validation data to the trained model, and compares the generated fate data, by the trained model, to the known fate data for the hybrid. The validation is satisfied when a threshold percentage of performance is reached, such as, for example, more than 75%, 80%, 90%, etc., of the predicted fates match the known fates of the hybrids. When the trained model is validated, the trained model is stored, by the computing device 102, in memory (e.g., the memory 204, etc.) for use in predicting the advancement of hybrids consistent with the request (e.g., by region, relative maturity, etc.).

It should be appreciated that in some examples the BLUPs may be calculated prior to training of the model (at step 308). In such examples, the BLUPs, once calculated, may be stored in memory of the computing device 102 or otherwise (e.g., in cloud storage, etc.) and then retrieved as needed (e.g., upon request by the computing device 102, in response to the request received at step 302, etc.). Alternatively, the BLUPs may be calculated as part of training the model, for example, as an additional step initiated in response to receiving the request at step 302, etc.

It should also be appreciated that the model may be trained apart from a request from a user to define hybrids predicted to be advanced, whereby the model is trained, stored, and ready to be used for a subsequent request. In such an embodiment, the computing device 102 may receive, optionally (as indicated by the dotted lines in FIG. 3) a request to define hybrids predicted to be advanced in the breeding pipeline 106 after training of the model, at 302a, whereby the computing device 102 accesses the trained model, from memory, at 304a.

Next in the method, after training and validating the model (at steps 302-310) (or after retrieving the trained model from memory (at steps 302a-304a)), and in response to the request, the computing device 102 identifies, at 312, potential combinations of inbred lines, or hybrids from the active inbred lines (e.g., one male inbred line and one female inbred line, etc.), included in the database 104 for the given region and based on the trait/characteristics included in the request, and specific to the trained model. For example, the inbred lines may be filtered for use in a particular region, such as, for example, North America, and then also, potentially, as having a specific relative maturity. As such, the inbred lines for North America and RM 100, for example, are used to identify the potential hybrid lines.

The computing device 102 may eliminate, optionally (as indicated by the dotted lines) ones of the identified potential hybrids, at 314, based on one or more criteria. For example, the computing device 102 may eliminate each hybrid which has already been tested, grown, or is otherwise already included in the breeding pipeline 106 (now or previously), as the outcome of the combination of inbred lines is already known or will be known. In another example, the identified potential hybrids inconsistent with a region and/or trait/characteristic of the request may be eliminated (e.g., where filtering prior to identifying the potential hybrids is omitted, etc.).

At 316, the computing device determines the probability of advancement of each of the potential hybrids in the breeding pipeline 106. In particular, the computing device 102 calculates, based on the trained model, the probability of advancement for each of the identified potential hybrids (i.e., not eliminate at 314), by providing the predictors (e.g., BLUPs, etc.) to the trained model (e.g., as shown in FIG. 4, etc.). The probabilities may be expressed on a scale from 0 to 1, as a percentage or otherwise, etc., whereby the higher the probabilities, the better chance of the potential hybrid being advanced beyond the threshold stage of the breeding pipeline 106. Again, it should be appreciated that in some examples the predictors (e.g., the BLUPs, etc.) may be calculated prior to application of the model at step 316 to determine the probability of advancement of the potential hybrids, whereby the predictors may be retrieved (e.g., as part of step 316, etc.) by the computing device 102 in connection with determining the probability of advancement. Alternatively, the BLUPs may be calculated on the fly (e.g., at step 316, etc.) as part of determining the probability of advancement of the potential hybrids.

The computing device 102 then generates, at 318, an output indicative of the potential hybrids (i.e., pairs of inbred lines) and one or more probabilities associated therewith to the user. The output may include an interface, which includes a listing of the top probabilities and associated identified hybrids. The interface may present the probabilities in numeric form and/or graphical form. In response to the output, the user may make a selection of one or more of the hybrids included in the output. Alternatively, the user may not select one or more of the hybrids.

In some examples, the output (e.g., the hybrids and/or the probabilities associated therewith, etc.) may be separated into bins, for example, based on the hybrids, based on the probabilities, etc. For instance, in one example, the computing device 102 may rank the potential hybrids based on their associated probability of advancement. Then, the computing device 102 may separate the hybrids into groups, or bins (e.g., 20 bins, etc.), based on the probabilities, such as a top 5% of the hybrids may be separated into bin 1, a second top 5% of the hybrids may be separated into bin 2, a third top 5% of the hybrids may be separated into bin 3, etc. And, one or more of the bins (and the hybrids and probabilities associated therewith) may be displayed to the user. As such, in this example, from the output the user may only need to look at bin 1 (which includes the top 5% of the hybrids) or bins 1 and 2 (which includes the top 10% of the hybrids) in making decisions as to which hybrids to advance into the pipeline 106. That said, in some embodiments, the computing device may automatically advance hybrids separated into bin 1, or hybrids separated into bins 1 and 2, etc. into the pipeline 106 (e.g., without further user selection or input).

Then, in response to the selection by the user or automatically based on the probabilities, at 320, the computing device 102 advances (e.g., directs, etc.) one or more of the hybrids to a hybrid pool of the breeding pipeline 106, whereby each of the hybrids in the hybrid pool is created, planted and tested. For instance, with reference to FIG. 1, the selected hybrids may be advanced to the breeding stage PS2.5 of the breeding pipeline 106, planted in a field (e.g., one of the fields 108 of the breeding pipeline 106, etc.) during the next growing season, and tested (in field) as part of PS2.5 products. Then, based on the performance of the hybrids (e.g., the results of the testing at PS2.5, etc.), the hybrids may be selected and moved into later stages of the breeding pipeline 106, for example, PS3, PS4, and CM, based on their field performance (e.g., the probability associated with the corresponding potential hybrid(s) may be validated, etc.). Alternatively, the hybrids may be dropped or removed from the breeding pipeline 106 at any stage after PS2.5 if performance is undesirable or insufficient, etc.

In view of the above, the systems and methods herein provide for objective selection of pairs of inbred lines for advancement as hybrids in a breeding pipeline. Further, in particular, the specific use of BLUP data for one or more traits of the inbred lines, as described above, provides for enhanced insights into the hybrids and improved accuracies of the probabilities associated therewith. The corresponding analysis thus provides for a technology based selection of hybrids, where certain pairs of inbred lines are correctly advanced in the breeding pipeline based on the analysis, while other pairs of inbred lines are not. In this manner, the overall performance of the breeding pipeline, as a technology, is improved, generally while reducing the overall resources of the pipeline.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure may transform a general-purpose computing device into a special-purpose computing device when configured to perform one or more of the functions, methods, and/or processes described herein.

As will be appreciated based on the foregoing specification, the above-described embodiments of the disclosure may be implemented using computer programming or engineering techniques, including computer software, firmware, hardware or any combination or subset thereof, wherein the technical effect may be achieved by performing at least one of the following operations: (a) accessing a trained model specific to a segment, the segment defined by a relative maturity (RM) and/or a region; (b) accessing data specific to multiple inbred lines, the data including best linear unbiased predictions (BLUPs) for one or more traits of the multiple inbred lines; (c) identifying pairs of the multiple inbred lines as combinations for potential hybrids; (d) calculating, with the trained model, a probability of advancement for individual ones of the potential hybrids in a breeding pipeline; and (c) advancing one or more of the ones of the potential hybrids into the breeding pipeline, based on the calculated probability of advancement for the individual ones of the potential hybrids.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above-mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in defining advancement of agricultural products in breeding, the method comprising:
accessing, by a computing device, a trained model specific to a segment, the segment defined by a relative maturity (RM) and/or a region;
accessing, by the computing device, data specific to multiple inbred lines, the data including best linear unbiased predictions (BLUPs) for one or more traits of the multiple inbred lines;
identifying pairs of the multiple inbred lines as combinations for potential hybrids;
calculating, by the computing device, with the trained model, a probability of advancement for individual ones of the potential hybrids in a breeding pipeline; and
advancing one or more of the ones of the potential hybrids into the breeding pipeline, based on the calculated probability of advancement for the individual ones of the potential hybrids.

2. The computer-implemented method of claim 1, wherein the trained model includes a random forest model; and/or
wherein the segment is defined by the RM and the region.

3. The computer-implemented method of claim 1, wherein the BLUPs include BLUPs based on an interval, the interval including a number of years; and/or
wherein the one or more traits of the multiple inbred lines includes yield.

4. The computer-implemented method of claim 1, wherein identifying the pairs of the multiple inbred lines includes identifying all unique pairs of one male of the inbred lines and one female of the inbred lines.

5. The computer-implemented method of claim 1, further comprising, prior to calculating the probability of advancement, eliminating other ones of the potential hybrids, based on inclusion of the other ones of the potential hybrids in a database of prior hybrids.

6. The computer-implemented method of claim 1, wherein each identified pair includes a male one of the multiple inbred lines and a female one of the multiple inbred lines.

7. The computer-implemented method of claim 1, further comprising, prior to accessing the trained model:
accessing historical data associated with multiple test inbred lines and the region, the historical data including BLUPs for one or more traits of the multiple test inbred lines and fate data for multiple hybrids including pairs of the multiple test inbred lines relative to a stage of the breeding pipeline; and
training the model based on at least a portion of the historical data.

8. The computer-implemented method of claim 7, further comprising validating the model based on data reserved from the accessed historical data the model.

9. The computer-implemented method of claim 1, further comprising outputting the calculated probability of advancement for the individual ones of the potential hybrids to a user.

10. The computer-implemented method of claim 1, wherein the crop includes corn.

11. The computer-implemented method of claim 1, wherein advancing the one or more of the ones of the potential hybrids into the breeding pipeline includes:
automatically directing the one or more of the ones of the potential hybrids into the breeding pipeline; and/or
planting at least one plant, consistent with the one or more of the ones of the potential hybrids, in a field included in the breeding pipeline, whereby the probability associated with the one or more of the ones of the potential hybrids is validated.

12. The computer-implemented method of claim 11, further comprising separating each of the potential hybrids into one of multiple groups based on the probability of advancement for the potential hybrid; and
wherein automatically directing, by the computing device, the one or more of the ones of the potential hybrids into the breeding pipeline includes automatically directing the potential hybrids separated into a particular one of the multiple groups into the breeding pipeline.

13. A non-transitory computer-readable storage medium including executable instructions, which when executed by at least one processor in connection with defining advancement of agricultural products in breeding, cause the at least one processor to:
access a trained model specific to a segment, the segment defined by a relative maturity (RM) and/or a region;
access data specific to multiple inbred lines, the data including best linear unbiased predictions (BLUPs) for one or more traits of the multiple inbred lines;
identify pairs of the multiple inbred lines as combinations for potential hybrids;
calculate, with the trained model, a probability of advancement for individual ones of the potential hybrids in a breeding pipeline; and
directing one or more of the ones of the potential hybrids into the breeding pipeline, based on the calculated probability of advancement for the individual ones of the potential hybrids.

14. The non-transitory computer-readable storage medium of claim 13, wherein the trained model includes a random forest model;
wherein the segment is defined by the RM and the region;
wherein the BLUPs include BLUPs based on an interval, the interval including a number of years; and
wherein the one or more traits of the multiple inbred lines includes yield.

15. The non-transitory computer-readable storage medium of claim 13, wherein the executable instructions, when executed by the at least one processor, further cause the at least one processor, prior to calculating the probability of advancement, to eliminate other ones of the potential hybrids, based on inclusion of the other ones of the potential hybrids in a database of prior hybrids.

16. The non-transitory computer-readable storage medium of claim 13, wherein the executable instructions, when executed by the at least one processor, further cause the at least one processor, prior to accessing the trained model, to:
access historical data associated with multiple test inbred lines and the region, the historical data including BLUPs for one or more traits of the multiple test inbred lines and fate data for multiple hybrids including pairs of the multiple test inbred lines relative to a stage of the breeding pipeline; and
train the model based on at least a portion of the historical data.

17. A system for use in defining advancement of agricultural products in breeding, the system comprising at least one computing device configured to:
access a trained model specific to a segment, the segment defined by a relative maturity (RM) and/or a region;
access data specific to multiple inbred lines, the data including best linear unbiased predictions (BLUPs) for one or more traits of the multiple inbred lines;
identify pairs of the multiple inbred lines as combinations for potential hybrids;
calculate, with the trained model, a probability of advancement for individual ones of the potential hybrids in a breeding pipeline; and
advance one or more of the ones of the potential hybrids into the breeding pipeline, based on the calculated probability of advancement for the individual ones of the potential hybrids.

18. The system of claim 17, wherein the trained model includes a random forest model;
wherein the segment is defined by the RM and the region;
wherein the BLUPs include BLUPs based on an interval, the interval including a number of years; and
wherein the one or more traits of the multiple inbred lines includes yield.

19. The system of claim 17, wherein the at least one computing device is configured, in order to advance the one or more of the ones of the potential hybrids into the breeding pipeline, to:
automatically direct the one or more of the ones of the potential hybrids into the breeding pipeline;
generate executable instructions for a planter to plant at least one plant, consistent with the one or more of the ones of the potential hybrids, in a field included in the breeding pipeline; and
transmit the executable instructions to the planter, to cause the planter to plant the at least one plant, consistent with the one or more of the ones of the potential hybrids, in the field, whereby the probability associated with the one or more of the ones of the potential hybrids is validated.

20. The system of claim 17, wherein the at least one computing device is further configured to separate each of the potential hybrids into one of multiple groups based on the probability of advancement for the potential hybrid; and
wherein the at least one computing device is configured, in order to automatically direct the one or more of the ones of the potential hybrids into the breeding pipeline, to automatically direct the potential hybrids separated into a particular one of the multiple groups into the breeding pipeline.
